(19) United States
(12) Patent Application Publication
(10) Pub. No.: US 2007/0237296 A1
(43) Pub. Date: Oct. 11, 2007

(54) Decontamination using planar X-ray sources

(76) Inventors: Jeffrey D. Wyatt, Berkeley, CA (US); Keith Bradley, New York, NY (US); John Barratt, San Jose, CA (US)

Correspondence Address: R'SUE POPOWICH CARON, 2750 ELMWOOD AVE., BERKELEY, CA, 94705, US

(21) Appl. No.: 11/224,830

(22) Filed: Sep. 13, 2005

Related U.S. Application Data
(60) Provisional application No. 60/609,412, filed on Sep. 13, 2004.

(51) Int. Cl. G21K 5/00

(52) U.S. Cl. 378/64

(57) ABSTRACT

A biological and chemical decontamination device that includes at least one planar x ray source, an irradiation chamber that receive the x rays, and at least one access port on the irradiation chamber through which port articles can enter the irradiation chamber is described. The planar x-ray source includes a planar field emission cathode having a plurality of nanotubes, an electron target for receiving electrons from the cathode, and an applied voltage that accelerates electrons from the cathode to the target. The cathode can be formed into a variety of shapes as needed for specific applications.

### BRIEF DESCRIPTION OF THE DRAWINGS

FIG. 1 is a computer image showing how electrons are emitted from a carbon nanotube field emitter tip in response to increasing electric field strength.

FIG. 2 is a cross-section view of a planar nanotube field emission x-ray unit.

FIGS. 3A and 3B show top views of two of many possible arrangements for nanostructures on a planar FEX cathode.

FIG. 4 is a diagram that shows a cross-section of a decontamination device according to an embodiment of the invention.

FIG. 5 is a diagram that shows a cross-section of a decontamination device according to another embodiment of the invention.

FIG. 6 is a diagram that shows a cross-section of a decontamination device according to another embodiment of the invention.

### DETAILED DESCRIPTION

The preferred embodiments are illustrated in the context of x-ray devices for biological and chemical decontamination of objects and fluids. The skilled artisan will readily appreciate, however, that the materials and methods disclosed herein will have application in a number of other contexts where small x-ray units are desirable, particularly where low power is important.

These and other objects and advantages of the present invention will become more fully apparent from the following description taken in conjunction with the accompanying drawings.

The terms “decontamination” and “sterilization” are used interchangeably throughout this disclosure to mean made safe by inactivating harmful substances such as chemical contaminants and especially live microorganisms, i.e., bacterial and viruses, which can cause harm to humans and animals.

The terms “nanostructures,” “nanowires,” “nanorods,” and “nanotubes” are used interchangeably herein to mean any nanostructures made of any material that forms nanostructures.

The term “planar x-ray source” is used to indicate an essentially planar source that emits x rays in a range of angles relative to the planar surface at substantially most regions of the surface. A planar source is distinct from both a point source and a line source. In the context of this disclosure, a planar x-ray source can be bent and convoluted into configurations other than a simple plane, such as a cylinder, and can emit x rays in a range of angles relative to the “plane” surface at substantially most regions of the surface. These complicated configurations are also referred to herein as planar x-ray sources.

As the anthrax outbreak of 2001 demonstrated, decontamination of surfaces exposed to biological agents poses a major challenge to military personnel and first responders. In some cases it took months for offices and buildings to be decontaminated and returned to service. Unlike carefully controlled hospital or medical settings, where decontamination and sterilization procedures are well known, field conditions are less well known and more challenging. An almost infinite variety of surfaces in an almost infinite variety of environmental settings may require decontamination and sterilization. Soil, concrete, carpets, clothing, ceiling tiles, paper and wood surfaces all must to be decontaminated if exposed to a biological agent.

Conventional decontamination methods used to decontaminate or sterilize surfaces can be broken into three categories: mechanical, chemical and physical.

Mechanical decontamination methods such as washing and vacuuming fail most often to remove completely or to inactivate infectious agents. Chemical decontamination methods can be very effective in inactivating infectious agents but are often impractical on porous surfaces or leave residues that present another set of problems. Physical methods employing heat or ionizing radiation work well but are very difficult to deploy effectively in the field. X-ray radiation has been proven to be effective in decontaminating and sterilizing surfaces and medical devices. X rays have the advantage of being able to penetrate almost any surface, especially when high energies are used.

To effectively use x-ray decontamination in a broader range of applications, a high-energy x-ray source that is small and light and requires only modest electrical power would be very useful. Conventional x-ray sources use electrons produced by thermionic emission to generate the x rays. These sources are large and inefficient, requiring high power, and are ill-suited for portable or tabletop use.

In order to produce x-rays, a target material is bombarded with energetic electrons. The electrons are accelerated by passing through a large electrostatic potential. The electrons must have enough energy to interact with atoms in the target and raise the atoms to excited energy states. The atoms release energy and return to their ground state by emitting x rays. The energies of the emitted x rays are characteristic of the target material.

In a conventional x-ray unit, the electron source is a thermionic emitter, e.g., a metal filament, operated at a very high temperature; the electrons are said to “boil off” the hot filament. The electrons are emitted in all directions. Metal plates surrounding the filament are maintained at high voltages to collimate and accelerate the electrons and shape them into a beam. However, the majority of emitted electrons are simply absorbed by the surrounding structures.

The target, from which the x rays are emitted, is simply a metal plate. In many applications, copper is used. When energetic electrons strike the target, x rays are emitted in all directions. Some x rays travel in useless directions, and are absorbed by the body of the target and the surrounding structure. Useful x rays leave the target through the x-ray window, which keeps vacuum in the apparatus while allowing x-rays to escape.

Note that any geometry which can maximize the fraction of x rays which are useful will maximize the overall efficiency of the source. Thus, targets are usually placed as near as possible to the window.

There are a number of problems in miniaturizing thermionic emitters for field deployment. The components must be placed in certain geometries relative to one another, and miniaturizing these geometries is difficult. The filament must operate at temperatures around 5000° F. Significant insulation must be placed around the filament, consisting partly of vacuum between the insulation and the walls and partly of solid insulation around the walls. Coolant is required for the walls and the filament support. Finally, the electrons represent only a tiny fraction of the total power deposited in the filament. The filament emits optical and infrared photons; indeed it is much brighter than a normal light bulb. Optical shielding is also required.

For some years now, field emission has offered an alternative source of energetic electrons, which can be used to produce x-rays. Field emission is a brighter, colder, more efficient electron source than is a thermionic emitter. In field emission, electrons are not boiled off a filament at high temperature, but rather are torn off by a high electric field. This approach offers numerous advantages for x-ray production. First, since the field emitter operates near room temperature, less complicated housings are required and cooling water is not necessary. Second, because the emitter is not maintained at a high temperature, essentially all the power is used to produce electrons. Field-emission electron sources are thus much more efficient. Finally, the electrons are emitted in a direction specified by the shape of the electric field. Thus, efficiency is improved yet further, as a larger fraction of the emitted electrons are able to go on to produce x rays. Additionally, much less electron shielding is needed to protect people nearby from stray electrons. In sum, a field emitter is analogous to a light-emitting diode. It emits only the electrons that are desired and only in the direction desired, thus making a bright, efficient and nearly monoenergetic beam.

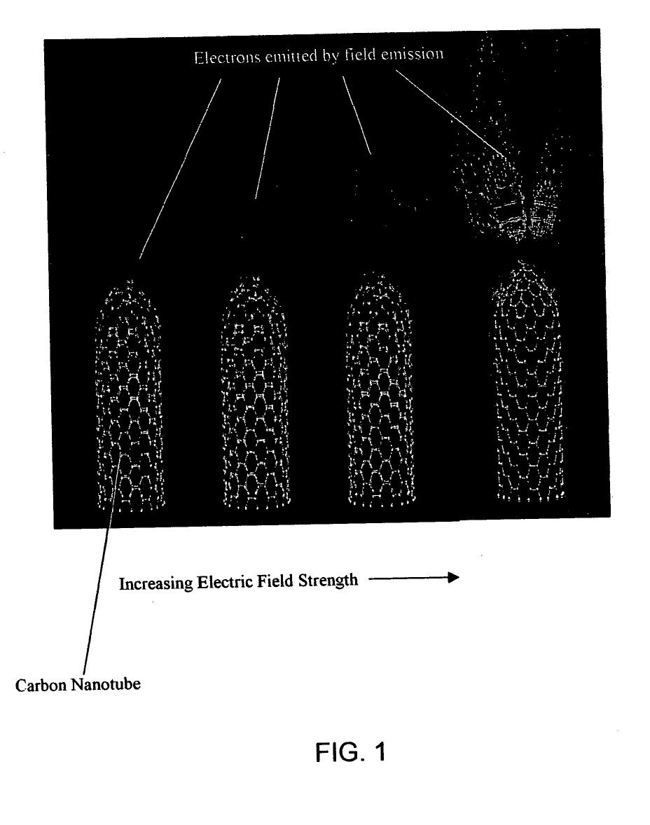

The field used in field emission is so high that there is very large mechanical stress on the tip. Only very strong materials can withstand this without failing. Before carbon nanotubes, the most common field emitters were individually made from single crystal tungsten. Few field emission tips were robust or stable enough to withstand the rigors of constant field emission. Field emitters were notoriously unstable and their performance was critically dependent on the strength of the filament and on maintaining very high vacuum conditions. Carbon nanotubes however, are extremely strong and robust. Second, they are intrinsically sharp, with single-walled carbon nanotubes having 1 nanometer (nm) tips uniformly. This diameter is smaller than can be produced by any other means now known. Because nanotubes do not have to be fabricated individually but are grown by the kilogram, they are inexpensive to produce. FIG. 1 shows electrons being pulled from a carbon nanotube field emitter tip. From left to right, the images show the electron intensity as the voltage (electric field) is increased.

One way to make a nanotube field emitter is to disperse nanotubes in conductive paste. The paste is deposited on an electrode, cured, and processed. Some nanotubes are randomly oriented parallel to the electrode, and don't participate in the emission. Some are oriented perpendicular or at other angles to the electrode, and they stick out of the paste. These nanotubes form field emission tips. Whenever any individual tip fails, other nearby tips are available to replace it.

Carbon nanotubes have benefited from much study and the are more well-characterized than nanotubes made from other materials. But, nanotubes can be made from many elements and compounds. Field emitters as described herein can be made from almost any nanotube material, as the emission of electrons is very strongly dependent on the sharpness and strength of the emitter tips and strength of the electric field, and somewhat less depending on the particular atoms in the tip. Any nanotube that has the necessary strength can be used.

Carbon nanotube field emission electron sources can be formed with a wide variety of geometries. They can be made in two or even three dimensions, unlike field emitters that have been made in the past. In two-dimensional arrays, carbon nanotubes are uniquely suited for flat panel displays. Several companies are developing flat panel displays based on carbon nanotube field emission.

X-ray sources provided in some embodiments of the invention use electrons generated by field emission (FEX) from nanostructures. Such sources are described in U.S. Pat. No. 6,553,096, to Zhou, incorporated herein by reference. In brief, the structure includes a cathode comprising nanostructures. The nanostructures provide long-lived, sharp tips for electron field emission. Many types of nanostructures can be used for this purpose, including, but not limited to, nanowires, nanorods, and nanotubes. The nanostructures can be made of any material that forms nanostructures. In some arrangements, the nanostructures are carbon nanotubes. The nanostructures may be mixed with a binder material to form a composite, as described in U.S. Pat. No. 6,057,637, to Zettl, hereby incorporated by reference.

Field emission from the cathode is induced by the application of an electric potential between the cathode and an emission electrode. When the cathode is maintained at a negative potential, the strong electric fields at the tips of the nanostructures cause emission of electrons from the nanostructures An anode target is provided, and the position of the target is arranged so that the emitted electrons bombard the target. The kinetic energy of the electrons as they leave the nanostructures must be at least as large as the energy of the x rays to be excited from the target. In some arrangements, the accelerating voltage is at least approximately 1.5 kV. In other arrangements, the accelerating voltage is at least approximately 3 kV. The target is made from a material which can emit x rays. The material can be a metal, such as iron, copper or manganese. Target materials emit x rays in energy ranges that are specific to the target material. Target materials are chosen to emit x rays in energy ranges that are most useful for the specific decontamination task.

In some embodiments of the invention, the emission electrode is identical with the accelerating electrode and anode target. In other embodiments, the emission electrode is distinct from the accelerating electrode, which is identical with the anode target. In still other embodiments, the emission electrode is distinct from the accelerating electrode, which is distinct from the anode target. In some embodiments, the accelerating electrode is in the form of a grid.

A field emission x-ray source differs from a conventional x-ray source in numerous advantageous ways. First, a field emission source does not need high temperatures for operation as does a conventional x-ray source. Consequently, there is no need for cooling apparatus, and the field emission source can be made small. Second, a field emission source is much more efficient than a conventional source. Efficiency is the rate of x-ray production divided by the power provided to the source. For a given amount of power, the more efficient the source the more x rays produced. Thus, a more efficient source uses less power to produce the same amount of x rays as a less efficient source. Both of these advantages, the size and the power requirements, make the inventive device more robust than decontamination devices using conventional x-ray sources.

An additional benefit of field-emission electron sources is that they can be turned on an off instantly, as the sources are entirely electrostatic. Field emission sources can be turned on and off within microseconds. By comparison, thermionic sources require time to heat up and time to cool down. Typically, a thermionic filament must be powered up for at least a few minutes before operation. This is described further in U.S. Pat. No. 6,876,724, to Zhou, which is hereby incorporated by reference herein. Thus, x-ray power can be reduced even further by operating the x-ray source only part of the time, rather than continuously as for conventional sources. A field emission x-ray source can be fully powered instantly when needed as for a decontamination activity. When a decontamination activity is finished, the power can be turned off before another decontamination activity is begun.

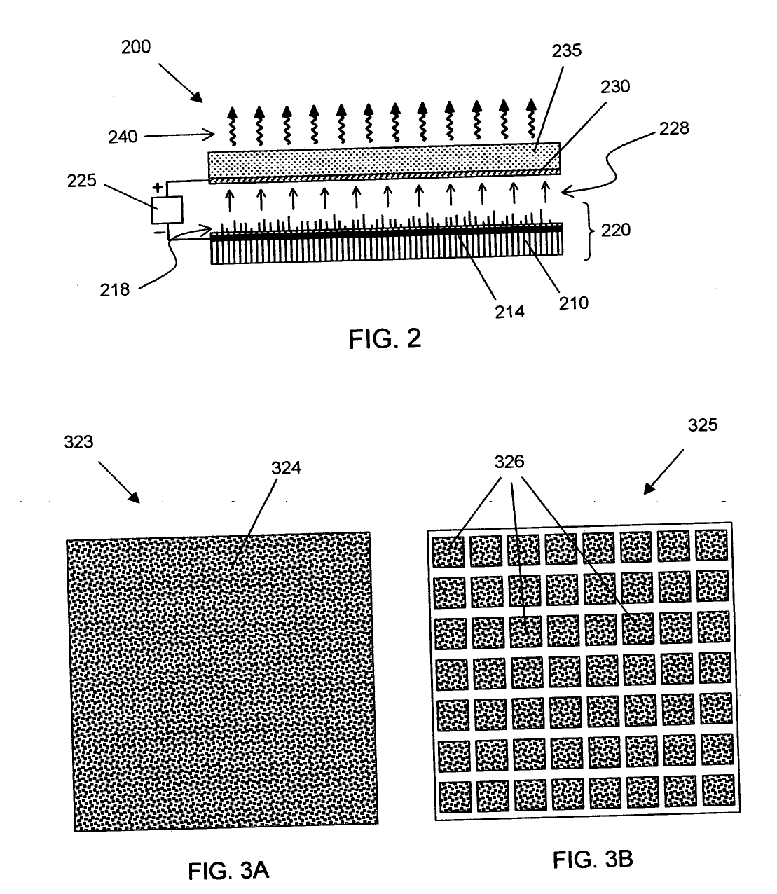

FIG. 2 is a cross-section view of a planar nanotube field emission x-ray (FEX) unit 200 according to some embodiments of the invention. The FEX unit 200 has an approximately planar field emission electron cathode 220. The cathode 220 has an emitter electrode 214 in electrical contact with nanostructures 218, such as carbon nanotubes, as described above, and can include a baseplate 210. A high voltage supply 225 can apply a high potential between the cathode 220 and a target material 230. In some arrangements, the target 230 is also an anode, as shown in FIG. 2. In other arrangements, the target 230 is not the anode, and a separate anode (not shown) is supplied. There can also be a faceplate 235 attached to the target 230. The faceplate 235 is transparent to at least some x rays. There is a vacuum between the nanostructures 218 and the target 230. When a high potential is applied between the cathode 220 and the anode 230, electrons 228 are emitted from the tips of the nanostructures 218 and are accelerated toward the target 230. When the electrons 228 interact with the target 230, x rays 240 are produced.

FIGS. 3A and 3B show top views of two of many possible arrangements for nanostructures on a FEX cathode. In FIG. 3A, a cathode 323 contains an approximately continuous distribution of nanostructure tips 324 that are available for electron emission. In FIG. 3B, a cathode 325 contains very many small islands, such as those indicated at 326, of nanostructure tips that are available for electron emission.

Electrical circuitry ensures that essentially all islands 326 are at an electrical potential that allows them to participate in field emission of electrons.

In some embodiments, an FEX device has the geometry of a rigid flat panel display. In other arrangements, an FEX device has a cathode that is planar and flexible and can be formed into at least a section of a sphere, cylinder, disc, approximately flat plane, cube, polyhedron, or more convoluted geometry. Through appropriate choice in baseplate material, emitter electrode material, and nanostructure material, the cathodes 323, 325 in FIGS. 3A, 3B can be made to be flexible. In other arrangements, the baseplate and the emitter electrode can be formed into a rigid or semi-rigid desired geometry and a flexible mat of nanostructures can be fitted onto the geometry in a way that electrical contact is made. In another arrangement, carbon nanotube paste is used as the nanostructure source. The paste can be spread onto an electrode and baseplate that have almost any geometry. Thus it is possible to build FEX radiation devices in almost any configuration.

It is well known that x rays can be used to deliver radiation doses that kill biological contaminants. Radiation can kill almost any microorganism, such as anthrax, e coli, Ebolla, and many other bacteria, viruses, and disease-causing agents, if the dose is appropriate. Doses in the range of 0.5 to 5 megarads are typical for killing most biological contaminants. In one embodiment of the invention a small, low power, field emission x-ray (FEX) decontamination instrument delivers approximately 1 megarad of ionizing radiation to a surface in approximately 1 second with only a moderate expenditure of power.

In one embodiment of the invention, a device for decontaminating thin objects, or the surfaces of thick objects, is described. For materials like polyethylene and paper, the major components of mail, approximately 67% of 10 kV x-rays are absorbed in the first 0.5 centimeter (cm). About 3×10¹⁵ x rays per cm² of surface can deliver a 1 megarad dose in the first 0.5 cm. A nanotube field-emitter providing 30 milliamps per centimeter squared (mA/cm²) of current corresponds to 3×10¹⁷ electrons/cm² in 1 second. In a highly conservative scenario, if the FEX device is only 1% efficient, then a nanotube field-emitter at 30 mA/cm² can provide the needed x rays in 1 second. A system that operates at 10 kilovolts (kV), 30 mA, and has an emitter 1 cm² in area sterilizes all microorganisms in a 1 cm² piece of mail in 1 second. It requires power equal to 30 mA×10 kV, or 300 watts (W). A 110 volt circuit can deliver 300 W with a current of 3 amps (A). Thus an FEX device capable of operating on a typical household 15 A circuit can sterilize 5 cm² of mail per second. With appropriate adjustments, devices for larger areas and deeper irradiation can be designed easily using the thought process described above. Other planar materials have different x-ray absorption characteristics. Again, adjustments can be made to deliver a dose of x rays that can decontaminate the surfaces of other planar materials to any depth desired. It will be appreciated by those skilled in the art that the inventive device can also be used according to methods already known.

In one embodiment, the electron emission current density from the nanotubes on the cathode is between about 10 and 1,000 milliamps per square centimeter. The electric field is between about 2 and 8 volts per micron.

X-ray sterilization devices using carbon nanotube field emission sources are uniquely flexible and effective biological sterilization devices that can be used by consumers, by business, by government and by the military to provide decontamination from harmful agents. In some embodiments, planar FEX decontamination devices can be used to denature chemical contamination, rendering it harmless.

In another embodiment of the invention, a nanotube FEX device can be used to decontaminate food. It has been a source of controversy in the food industry about whether irradiating fruits and vegetables can insure healthfulness and slow down the spoiling process. In general, the food industry seems to think that the benefits outweigh the risks. A consumer version of a nanotube FEX device allows individual consumers to make the decision for themselves. This would be especially useful during periodic scares such as about e coli in meat and salmonella in eggs. Restaurants and military meal providers can also find use for nanotube FEX decontamination devices.

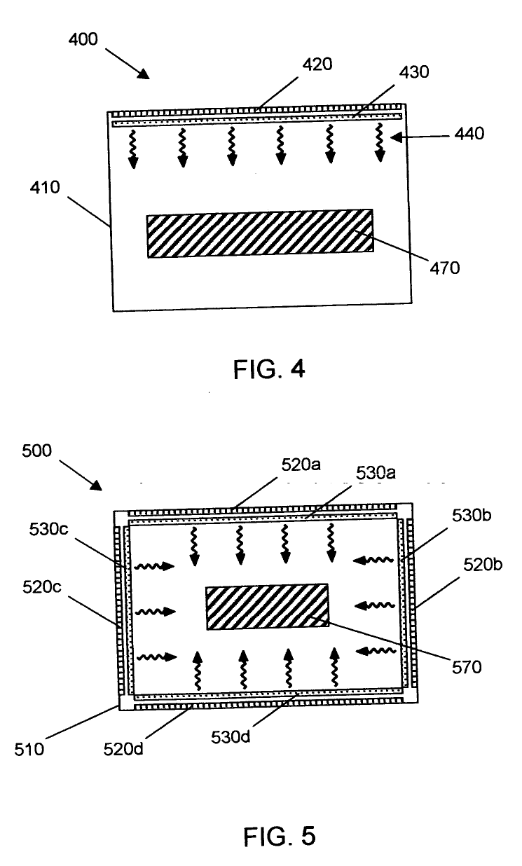

FIG. 4 is a diagram that shows a cross-section of a decontamination device 400 according to an embodiment of the invention. The device 400 has a decontamination chamber 410. Along one surface of the chamber 410, there is a planar nanotube field emission x-ray unit that includes a nanotube cathode 420 and a target material 430. A contaminated article 470 can be placed in the chamber 410 and the FEX unit can be activated. X rays 440 are emitted from the target 430 and the article 470 is irradiated, killing the contamination. The device 400 is especially useful when the article 470 is thin or when most of the contamination is on the surface of the article 470 that faces the target 430.

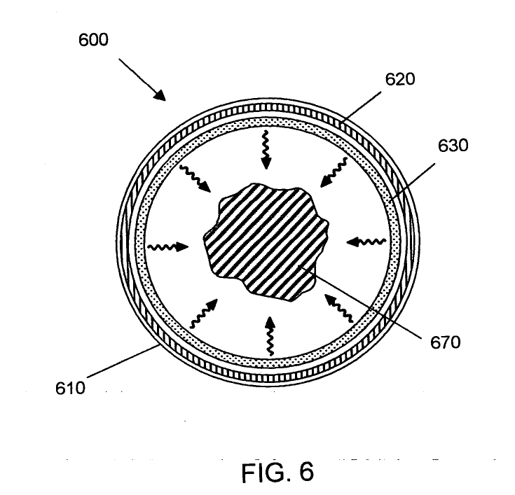

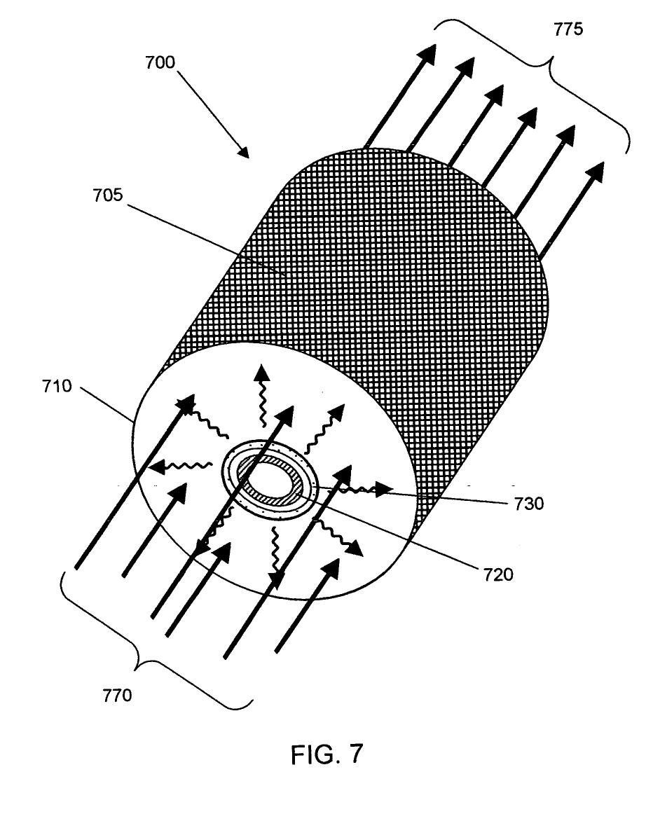

FIG. 5 is a diagram that shows a cross-section of a decontamination device 500 according to another embodiment of the invention. The device 500 has a decontamination chamber 510. Along each surface of the chamber 510, there is a planar nanotube field emission x-ray unit that includes a nanotube cathode 520a, 520b, 520c, 520d and a target material 530a, 530b, 530c, 530d, respectively. A contaminated article 570 can be placed in the chamber 510 and the FEX unit can be activated. X rays are emitted from all targets 530a, 530b, 530c, 530d and the article 570 is irradiated, killing the contamination. The device 500 is especially useful when the article 570 is thick or when the contamination of concern is on all surfaces of the article 570 that face the targets 530a, 530b, 530c, 530d.

In other embodiments, all surfaces of the chamber of the decontamination device contain planar FEX units. In yet other embodiments, only some surfaces of the chamber of the decontamination unit contain planar FEX units.

A planar FEX decontamination unit can also have an access port (not shown in FIGS. 4, 5) that can be opened to gain entry to the decontamination chamber and closed to seal the chamber before activating the FEX unit(s). As is well-known in the art, x-ray shielding can also in included in the walls of the chamber to prevent unwanted scattering of x-rays outside the decontamination device.

FIG. 6 is a diagram that shows a cross-section of a decontamination device 600 according to another embodiment of the invention. The device 600 has a cylindrical decontamination chamber 610. Along the circular walls of the chamber 610, there is a planar nanotube field emission x-ray unit that includes a nanotube cathode 620 and a target material 630. A contaminated article 670 can be placed in the chamber 610 and the FEX unit can be activated. X rays are emitted from the target 630 and the article 670 is irradiated, killing the contamination. The device 600 can be used for solid or for fluid (liquid or gas) articles 670. As a contaminated fluid flows through the cylindrical chamber 610, the flow rate can be adjusted to be sure the fluid receives dose of x rays that will kill or denature the contaminants.

FIG. 7 is a diagram that shows a decontamination device 700 according to another embodiment of the invention. The device 700 has a cylindrical decontamination chamber 710. Approximately along the center axis of the chamber 710, there is a planar nanotube field emission x-ray unit bent into a cylindrical configuration, which includes a nanotube cathode 720 and a target material 730. In one arrangement a voltage difference between the cathode 720 and an anode associated with the target 730 is between about 2 and 7 kV. In another arrangement a voltage difference between the cathode 720 and an anode associated with the target 730 is between about 3 and 5 kV. In another arrangement, the voltage difference is about 3.5 kV.

Contaminated fluid, as indicated by arrows 770 can enter the chamber 710 and the FEX unit can be activated. X rays are emitted from the target 730 and the fluid 770 is irradiated, killing the contamination. As the contaminated fluid 770 flows through the cylindrical chamber 710, the flow rate can be adjusted to be sure the fluid receives a dose of x rays that will kill or denature the contaminants. Decontaminated fluid indicated by arrows 775 exits the device 700. X-ray shielding 705 is shown around the cylindrical chamber 710. Other shielding (not shown) can be provided, as appropriate for the application. In other arrangements, the decontamination device 700 does not also shield x rays.

There can also be fans or other fluid movement apparatus (not shown) associated with the device 700. In other arrangements, the device 700 can be installed as part of the intake or the output of a ventilation system for a ventilated space, such as a building, a vehicle (car, boat, airplane, tank, etc.) or for a self-contained breathing apparatus. The device 700 can also be installed as part of a water supply system or as part of a liquid waste disposal system. For example, the device 700 can ensure the safety of drinking water or can ensure the safety of sewage leaving a known contamination source, such as a hospital.

This invention has been described herein in considerable detail to provide those skilled in the art with information relevant to apply the novel principles and to construct and use such specialized components as are required. However, it is to be understood that the invention can be carried out by different equipment, materials and devices, and that various modifications, both as to the equipment and operating procedures, can be accomplished without departing from the scope of the invention itself

We claim:

1. A decontamination device comprising:
at least one planar x ray source;
an irradiation chamber configured to receive x rays from the x-ray source; and
a first access port on the irradiation chamber through which port articles can enter the irradiation chamber.

2. The device of claim 1, wherein the planar x-ray source comprises:
a planar field emission cathode having a plurality of nanotubes, the cathode formed into a shape;
an electron target for receiving electrons from the cathode; and
an applied voltage configured to accelerate electrons from the cathode to the target.

3. The planar x-ray source of claim 1, wherein the shape is at least a section of a shape selected from the group consisting of sphere, cylinder, disc, approximately flat plane, cube, and polyhedron.

4. The device of claim 1, further comprising a first exit port on the irradiation chamber through which exit port the articles can exit the irradiation chamber.

5. The device of claim 1 wherein the articles are selected from the group consisting of solids, liquids, and gases.

6. A planar field emission x-ray source comprising:
a planar cathode baseplate and electrode formed into a shape;
a plurality of nanotubes having exposed tips available for electron emission, the plurality of nanotubes in electrical contact with the electrode;
an electron target configured to receive accelerated electrons from the nanotubes; and
an applied voltage configured to accelerate electrons from the cathode to the target.

7. The x-ray source of claim 6, wherein the shape is at least a section of a shape selected from the group consisting of sphere, cylinder, disc, approximately flat plane, cube, and polyhedron.
